(19) United States
(12) Patent Application Publication
(10) Pub. No.: US 2015/0224588 A1
(43) Pub. Date: Aug. 13, 2015

(54) Saw Blade Tooth Geometry For a Circular Saw Blade

(71) Applicants: Robert Bosch Tool Corporation, Broadview, IL (US); Robert Bosch GmbH, Stuttgart (DE)

(72) Inventor: Russell Thomas Kohl, Roswell, GA (US)

(21) Appl. No.: 14/689,804

(22) Filed: Apr. 17, 2015

Related U.S. Application Data
(63) Continuation-in-part of application No. 11/818,753, filed on Jun. 15, 2007, now abandoned.

(51) Int. Cl. B23D 61/02; B23D 61/04

(52) U.S. Cl. CPC B23D 61/021; B23D 61/04

(57) ABSTRACT

A circular saw blade includes a generally flat disk with a cutting periphery defined by a plurality of carbide teeth arranged in spaced relation around the perimeter of the disk and projecting radially outwardly from the disk. Each tooth of the cutting periphery includes a pair of spaced-apart primary side faces, a cutting face having a cutting edge with a top bevel angle within the range of at least 25 degrees to about 50 degrees, and at least two secondary side faces. Each secondary side face extends between the cutting face and a respective one of the pair of primary side faces and has a relief angle relative to the immediately adjoining primary side face. The circular saw blade is ably suited to provide a smooth cutting finish without splintering of the top and bottom edges in connection with a wide variety of cuts, including crosscutting and ripcutting.

This application claims the benefit of U.S. application Ser. No. 11/818,753 filed Jun. 15, 2007, the entirety of which is incorporated herein by reference.

### FIELD

The present disclosure relates generally to circular saw blades and, in particular, to a circular saw blade tooth geometry for providing a smoother, more finished cut in a wide variety of materials.

### BACKGROUND

Circular saw blades have broad utility across a range of industries for use in cutting wood and other materials. Typically machine-driven, circular saw blades feature a serrated peripheral edge composed of a plurality of teeth projecting radially away from the center of the blade. These teeth, which are responsible for performing the cutting action in the work piece, are usually composed of a durable, corrosion-resistant material, such as carbide.

Different types of saw blades, each with specific tooth geometries, are known to be advantageous in accomplishing various types of cuts in a work piece. As is well known in the art, two of the most common types of cuts to be made are crosscuts and rip cuts. Crosscuts are cuts that are made at or near a right angle with respect to the direction of the grain in the work piece. Rip cuts are cuts that are made parallel to the direction of the grain of the work piece. While varying types of saw blades are useful in accomplishing either crosscuts or rip cuts, certain characteristics of saw blades and, particularly, their corresponding tooth geometries, are known to have particular importance in accomplishing a desired cut.

For example, in conventional circular saw blades, it is known to utilize a saw blade having teeth with a “high” top bevel angle greater than 25 degrees in conjunction with a primary side grind angle to accomplish crosscuts in a work piece. The top bevel angle is a measure of the bevel angle at the tip of the tooth where the cut is initiated. The primary side grind angle refers to the radial or side clearance angle on either side of the tooth. In many of these circular saw blades, the orientation of the top bevel angle alternates between a right-handed bevel and a left-handed bevel for each successive tooth along the periphery of the saw blade. For this particular variety of known circular saw blades, the top bevel angle is referred to as “high” due to the substantial increase in the angle size over other types of circular saw blades commonly used in connection with crosscutting, which typically have a top bevel angle in the range of 5 to 10 degrees. Circular saw blades with a high top bevel angle greater than 25 degrees in conjunction with a primary side grind are known to provide smooth top side and bottom side surfaces in a work piece where a cut is made. However, the end surface of the work piece, which is the narrow surface between the top and bottom side surfaces that is in contact with the tips of the teeth as a cut is being made, is often left unpolished with a hatched, unfinished appearance. Such saw blades that combine a high alternating top bevel angle with a primary side grind are also known to be difficult to use in connection with rip cuts, particularly with respect to ripping thicker stock wood having a thickness between about 1.3 cm (0.5 inches) and about 5.7 cm (2.25 inches).

Other known circular saw blades utilize an alternating top bevel angle of less than or equal to 20 degrees in conjunction with a primary side grind and a secondary side grind at either side of the tooth. The top bevel angle in such blades is typically much smaller than the angle found in so-called “high” top bevel angle blades and is often much less than 20 degrees. As before, the primary side grind refers to the radial or side clearance angle on either side of the tooth. Additionally, a secondary side grind is included on either side of each tooth extending between each of the two primary sides and the front cutting face of the tooth to provide an additional beveled surface on either side of the tooth. In this regard, a circular saw blade that combines primary and secondary side grind in conjunction with an alternating top bevel angle of less than or equal to 20 degrees is capable of accomplishing crosscuts having a smooth, polished end grain finish at the end surface of a cut. However, the top side and bottom side surfaces of the cut area are often left splintered and uneven, thus requiring further treatment of the work piece before implementation or further modification of the work piece in a project. Additionally, such saw blades that combine primary and secondary side grind with an alternating top bevel angle of less than or equal to 20 degrees are known to be difficult to use in connection with rip cuts, particularly with respect to ripping thicker stock wood having a thickness between about 1.3 cm (0.5 inches) and about 5.7 cm (2.25 inches).

Accordingly, a need exists for a versatile circular saw blade capable of accomplishing a wide variety of cuts, including both crosscuts and rip cuts. Further, a need exists for a versatile circular saw blade capable of providing a smooth, polished end grain finish at the end surface without splintering the top side and bottom side surfaces of a cut. Further still, a need exists for a versatile circular saw blade capable of use in connection with a wide range of different work piece thicknesses.

### SUMMARY

In accordance with one embodiment, a circular saw blade includes a generally flat disk having a cutting periphery defined by a plurality of carbide teeth arranged in spaced relation around the perimeter of the disk and projecting radially outwardly from the disk. Each tooth of the cutting periphery includes a pair of spaced-apart primary side faces, a cutting face having a cutting edge with a top bevel angle within the range of at least 25 degrees to about 50 degrees, and at least two secondary side faces, each extending between the cutting face and a respective one of the pair of primary side faces. The secondary side faces each have a relief angle relative to the immediately adjoining primary side face.

In various preferred embodiments, the plurality of teeth are arranged along the cutting periphery such that they are evenly spaced around the circumference of the disk. Additionally, the orientation of the top bevel angle may alternate between adjacent teeth along the cutting periphery. In another preferred embodiment, the top bevel angle is preferably between the range of about 30 degrees and about 40 degrees. The relief angle between each of the secondary side faces and the respective immediately adjoining primary side face is preferably at least 1 degree and not more than 2 degrees. Additionally, the pair of spaced-apart primary side faces may be spaced such that, together, they define the kerf of the saw blade.

Some embodiments may also include a carbide cutting tooth for a circular saw blade that includes a pair of spaced-apart primary side faces, a cutting face having a cutting edge with a top bevel angle within the range of at least 25 degrees to about 50 degrees, and at least two secondary side faces, each extending between the cutting face and a respective one of the pair of primary side faces. The secondary side faces each have a relief angle relative to the immediately adjoining primary side face.

Further areas of applicability of the present disclosure will become apparent from the detailed description provided hereinafter. It should be understood that the detailed description and specific examples, while indicating the preferred embodiments of the disclosure, are intended for purposes of illustration only and are not intended to limit the scope of the disclosure.

### BRIEF DESCRIPTION OF THE DRAWINGS

The accompanying drawings illustrate various embodiments of the present disclosure and together with a description serve to explain the principles of the disclosure.

FIG. 1 is a side elevation view of a circular saw blade having a plurality of teeth in accordance with the present disclosure;

FIG. 2 is a partial cutaway perspective of the circular saw blade of FIG. 1, showing three of the plurality of teeth;

FIG. 3 is a front elevation view of an individual tooth of the saw blade of FIG. 1;

FIG. 4 is a side elevation view of an individual tooth of the saw blade of FIG. 1; and

FIG. 5 is a top plan view of an individual tooth of the saw blade of FIG. 1.

Corresponding reference characters indicate corresponding parts throughout the several views. Like reference characters indicate like parts throughout the several views.

### DETAIL DESCRIPTION OF THE DISCLOSURE

While the power tools described herein are susceptible to various modifications and alternative forms, specific embodiments thereof have been shown by way of example in the drawings and will herein be described in detail. It should be understood, however, that there is no intent to limit the power tools to the particular forms disclosed. On the contrary, the disclosure is to cover all modifications, equivalents, and alternatives falling within the spirit and scope of the disclosure as defined by the appended claims.

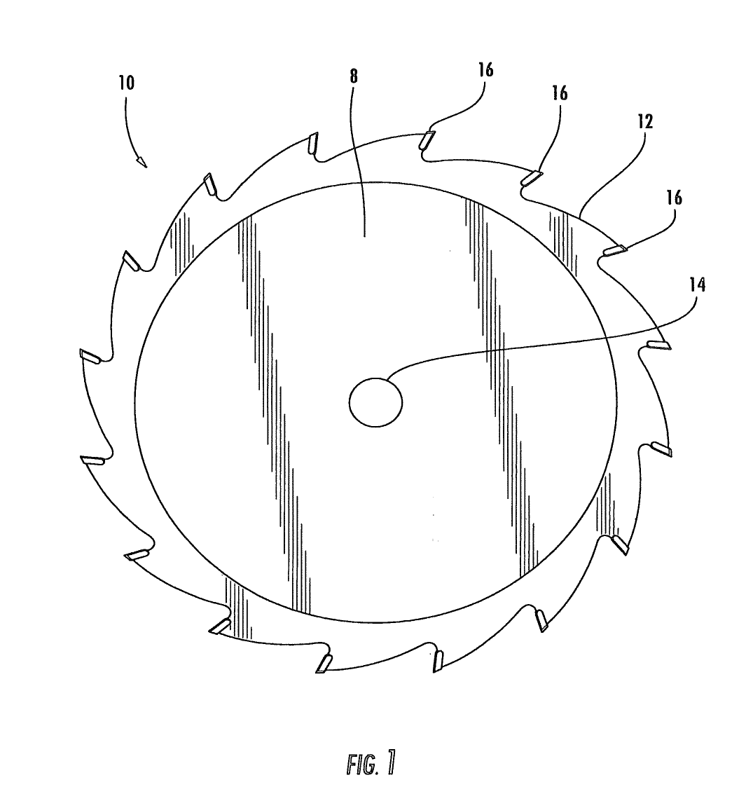

Referring now to the drawings in which like reference numerals designate like or corresponding parts throughout the several views, there is shown in FIGS. 1-5 a circular saw blade incorporating tooth geometry in accordance with the present invention. Circular saw blade 10 comprises a generally flat circular disk 8 having a central bore 14 and a cutting periphery 12 that includes a plurality of teeth 16. The disk 8 may have any diameter or thickness as might be contemplated by one of ordinary skill in the art in accordance with a preferred end use for the saw blade 10. The disk 8 is advantageously composed of a strong and durable material, such as a high strength grade of steel or other similar metals, so that the saw blade is capable of use in cutting a range of different types of work pieces, including, but not limited to, plywood, melamine, chipboard and fiber board. The central bore 14 of the saw blade 10 facilitates the saw blade being mounted on and driven by a machine, as is well known in the art.

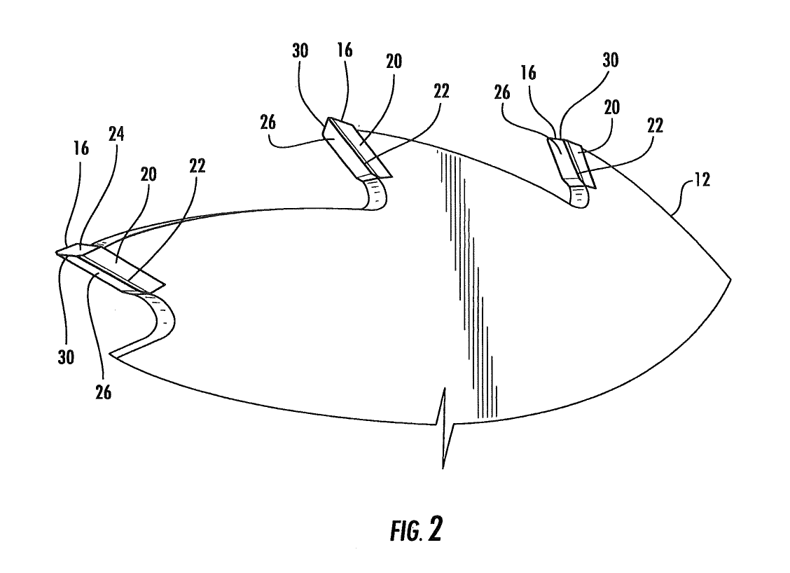

As shown in FIGS. 1 and 2, the cutting periphery 12 of the saw blade 10 includes a plurality of teeth 16 spaced evenly along the cutting periphery 12 and projecting radially outwardly away from the center of the saw blade 10. The plurality of teeth 16 collectively provide the cutting periphery 12 with the serration necessary to accomplish the cutting action when the saw blade 10 is used. The plurality of teeth 16 along the cutting periphery 12 may be machined into the saw blade 10 such that each tooth 16 is integral with the saw blade 10. However, it is also within the scope of the present invention that the teeth 16 are separate components configured to be fixedly attached to the cutting periphery 12, thus permitting individual teeth to be replaced in the event of possible damage to the saw blade 10. The teeth 16 are advantageously composed of a highly durable material, such as carbide, to protect against possible damage and wear to the specific geometry of the tooth shape. Each tooth 16 of the cutting periphery 12 is described in greater detail below.

As shown in FIGS. 2-5, each tooth 16 has a pair of spaced-apart primary side faces 20, a cutting face 26, and a pair of secondary side faces 22 extending between the cutting face 26 and a respective one of the pair of primary side faces 20. At the tip of each tooth 16, projecting outwardly away from the center of the saw blade 10, is the tip face 24. The faces 20, 22, 24, 26 of each tooth 16 collectively define the tooth geometry, which facilitates the saw blade 10 being capable of accomplishing a desired cut. Additionally, the edge of the cutting face 26 that adjoins the tip face 24 represents a culminating tip 30 of each tooth 16 and is therefore preferably configured to be a sharpened cutting edge.

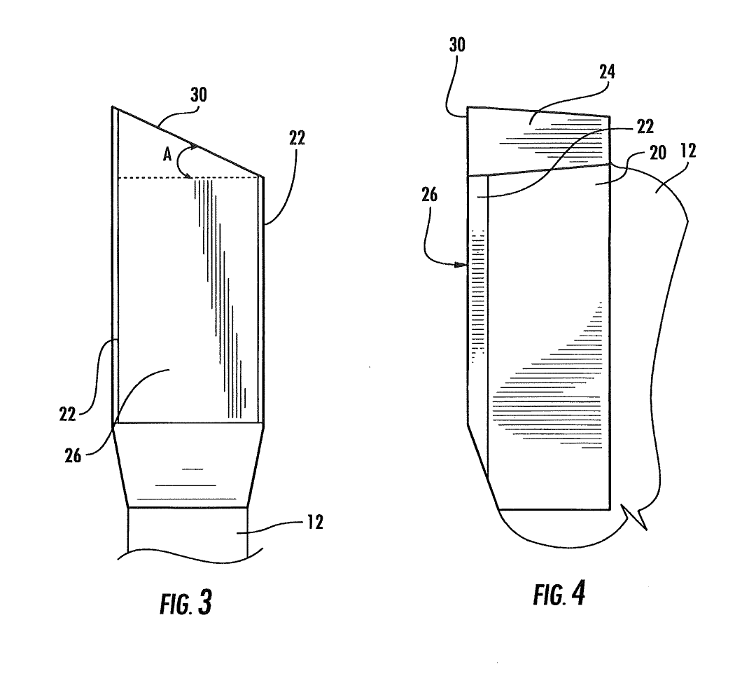

As shown specifically in FIGS. 2 and 3, each tooth 16 has a high top bevel angle A at the tip thereof, which is defined by the culminating tip 30 of the cutting face 24 relative to an imaginary line running perpendicular to the side edges of the cutting face 24. The orientation of the high top bevel angle A preferably reverses between a left-handed bevel and a right-handed bevel along successive teeth 16 of the cutting periphery 12, as shown in FIG. 2. The high top bevel angle A is at least 25 degrees, and is typically within the range of 25 degrees and about 50 degrees. In a preferred embodiment, the high top bevel angle A is within the range of about 30 degrees and about 40 degrees. As is also shown in FIGS. 2 and 3, the high top bevel angle A creates in the cutting face 26 a tapered shape, which assists in the creation of chip-free top side and bottom side surfaces of a cut in a work piece.

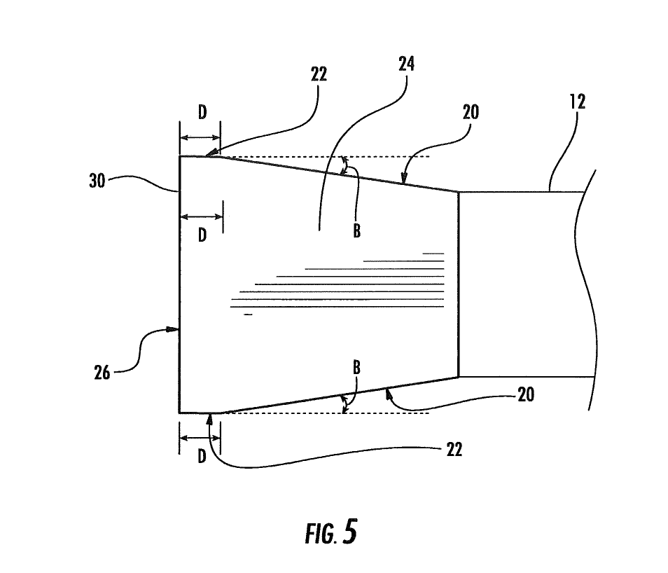

As shown in FIGS. 2-5, each tooth 16 combines the high top bevel angle A with primary and secondary side faces 20, 22. The primary side faces 20 of each tooth 16 provide the primary side grind on either side of the tooth 16, which is known to provide smooth top side and bottom side surfaces in a work piece when used in conjunction with a high top bevel angle. As best seen in FIG. 5, the primary side faces 20 of the tooth 16 are preferably angled away from the surface defined by the disk 8 and the surrounding cutting periphery 12. Thus, by virtue of their position at opposite sides of the tooth 16, the primary side faces 20 at their widest point define the width of the kerf of the saw blade 10.

The secondary side faces 22 of each tooth 16 provide the secondary side grind on either side of the tooth, which, in combination with the primary side grind and the high top bevel angle, provides broad versatility to the saw blade with respect to accomplishing differing types of polished, finished cuts in widely varying materials with a single saw blade. As shown in FIGS. 2-5, each secondary side face 22 of each tooth 16 is a narrow surface that extends between the respective primary side face 20 and the cutting face 26. As best seen in FIG. 5, the narrow width portion of each secondary side face 22 is indicated as the distance D. Additionally, each secondary side face 22 is configured within the overall tooth geometry to provide a relief angle B relative to the immediately adjoining primary side face 20. The relief angle B may have different sizes. In a preferred embodiment, the relief angle B is relatively small and is in the range of about 1 to 2 degrees. As best seen in FIG. 5, the relief angle B is shown in a relatively exaggerated state so as to clearly depict each of the primary and secondary side faces 20, 22 in profile.

As shown in FIGS. 2-5, the secondary side faces 22 of each tooth 16 provide an additional surface to the tooth geometry. When a saw blade in accordance with the present invention is in use, the secondary side faces 22 of each tooth 16 provide the saw blade 10 with the ability to burnish the workpiece by pushing away excess fibers removed by the cutting process as the cut is being made. Utilizing the secondary side faces 22 in conjunction with primary side faces 20 and the high top bevel angle A in each tooth 16 of the saw blade 10 provides one of the significant advantages associated with the present invention. This combination of features is useful in conjunction with accomplishing both crosscuts and rip cuts in a range of different materials. Additionally, this combination of features yields a polished, finished cut in the work piece, whereby the top side, bottom side and end side surfaces of the cut are left smooth without hatching or chipping upon completion of the cut. Further still, this combination of features facilitates use of the saw blade in connection with accomplishing cuts across a wide range of different materials having a thickness ranging from about 1.3 cm (0.5 inches) to about 5.7 cm (2.25 inches). The ability to accomplish cuts, and particularly rip cuts, in thicker work pieces is an advantage that neither the high top bevel angle in the tooth geometry or the primary and secondary side faces in the tooth geometry has been known to be capable of accomplishing when implemented in the tooth geometry in isolation.

Preferably, tooth size, shape and configuration on a single saw blade remain the same for each tooth 16 of a single saw blade, although it is also within the scope of the present invention that specific teeth along the cutting periphery 12 may be sized, shaped or configured differently to accomplish a desired variation in the cut.

In accordance with other aspects of the present invention, the tooth pitch of the saw blade 10, which refers to the spacing between adjacent teeth 16 along the cutting periphery 12, may be any tooth pitch that might be preferred for a particular end use. A smaller tooth pitch is typically associated with crosscutting, where more teeth on a single saw blade is preferable to leave a cleaner cut behind. A larger tooth pitch, on the other hand, is typically associated with rip cutting, with the preferred tooth pitch typically increasing as the thickness of the material to be cut increases. With respect to the saw blade of the present invention, the tooth pitch is preferably selected to reflect the versatility of the saw blade with respect to both crosscutting and rip cutting. In this regard, the tooth pitch is preferably within the range of about 17 mm and about 27 mm.

Additionally, the hook angle of the teeth 16 may be any hook angle that might be preferred, as would be appreciated by one of ordinary skill in the art. The hook angle is the angle formed by the plane defined by the cutting face 26 of the tooth 16 and a line drawn from the center of the saw blade 10 across the culmination tip 30 of the tooth 16. The hook angle may be a positive angle, whereby the teeth 16 are angled toward the direction of the saw blade rotation; a negative hook angle, whereby the teeth 16 tip are angled away from the direction of saw blade rotation; or a zero degree hook angle, whereby the teeth 16 are generally in line with the center of the saw blade 10.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. A carbide cutting tooth for a circular saw blade comprising:
a pair of spaced-apart primary side faces;
a cutting face having a cutting edge with a top bevel angle within the range of at least 25 degrees to about 50 degrees, and having two side edges located on each side of the cutting face; and
at least two secondary side faces, each secondary side face extending between the cutting face and a respective one of the pair of primary side faces, the secondary side faces each having a relief angle relative to the immediately adjoining primary side face, wherein the two secondary side faces have an extending length corresponding generally to an extending length of the each two side edges of the cutting face, the circular saw blade having a tooth pitch within the range of 17 mm to 27 mm.

2. The cutting tooth of claim 1 wherein the top bevel angle is an angle within the range of about 30 degrees to about 40 degrees.

3. The cutting tooth of claim 1 wherein the relief angle is at least 1 degree and not more than 2 degrees.

4. The cutting tooth of claim 1 wherein the pair of spaced apart primary side faces define the kerf of the saw blade.

5. A circular saw blade comprising:
a generally flat disk having a cutting periphery defined by a plurality of carbide teeth arranged in spaced relation around the perimeter of the disk and projecting radially outwardly from the disk, each tooth including
a pair of spaced-apart primary side faces,
a cutting face having a cutting edge with a top bevel angle within the range of at least 25 degrees to about 50 degrees and
at least two secondary side faces, each secondary side face extending between the cutting face and a respective one of the pair of primary side faces, the secondary side faces each having a relief angle relative to the immediately adjoining primary side face, wherein the two secondary side faces each have an extending length corresponding generally to the extending length of one of two side edges of the cutting face, the circular saw blade having a tooth pitch within the range of 17 mm to 27 mm.

6. The circular saw blade of claim 5 wherein the plurality of teeth are evenly spaced around the circumference of the disk.

7. The circular saw blade of accordance with claim 5 wherein the orientation of the top bevel angle alternates between adjacent teeth along the cutting periphery.

8. The circular saw blade of claim 5 wherein the top bevel angle is an angle within the range of about 30 degrees to about 40 degrees.

9. The circular saw blade of claim 5 wherein the relief angle is at least 1 degree and not more than 2 degrees.

10. The circular saw blade of claim 5 wherein the pair of spaced-apart primary side faces define the kerf of the saw blade.
